(19) United States
(12) Patent Application Publication
(10) Pub. No.: US 2006/0145022 A1
(43) Pub. Date: Jul. 6, 2006

(54) Propellant tank baffle system

(76) Inventor: David Benjamin Buehler, Provo, UT (US)

Correspondence Address: David Buehler, 893 W 2150 N, Provo, UT, 84604, US

(21) Appl. No.: 11/301,572

(22) Filed: Dec. 12, 2005

Related U.S. Application Data
(60) Provisional application No. 60/634,863, filed on Dec. 10, 2004.
(60) Provisional application No. 60/634,864, filed on Dec. 10, 2004.

(51) Int. Cl. B64G 1/00

(52) U.S. Cl. 244/172.2

(57) ABSTRACT

The invention disclosed here is a pressurization system for pressure-fed launch vehicles. The system employs a hot pressurant gas to minimize the mass of pressurant gas required. It also employs a set of baffles within the propellant tank to reduce heat transfer between the propellant and the hot pressurant gas. The baffles keep the pressurant gas flowing uniformly in one direction as the propellant is expelled, and inhibit mixing of the cold gas near the propellant with the hot gas being blown into the tank. The baffles also prevent large-scale sloshing of the propellant. The metal baffles are rigidly attached to one end of the tank and attached with a mount which allows travel in the longitudinal direction but not in the two lateral directions which minimizes stess on the pressure vessel from differences in thermal expansion.

This application claims the benefit of provisional applications No. 60/634,863 filed Dec. 10, 2004 entitled “Composite propellant tank with a system of metal baffles”, and provisional applications No. 60/634,864 filed Dec. 10, 2004 entitled “Hot gas pressurization system utilizing baffles”.

It also references USPTO disclosure document number 549182 filed Mar. 15, 2004, entitled “Composite Propellant Tank With A System of Metal Baffles”.

### BACKGROUND OF THE INVENTION

1. Field of the Invention

This invention relates to gas pressurization systems. Gas pressurization systems are used to maintain pressure within a pressure vessel filled with fluid while the fluid is being expelled. More specifically, it relates to gas pressurization systems employed on rocket stages.

2. Description of Related Art

This invention in its main embodiment is intended for use in a rocket vehicle. Rocket vehicles can be either pump-fed or pressure-fed. In a pump-fed vehicle, a pump boosts the pressure of the propellant from the pressure of the propellant tank to the high pressure required for injection into the engine. For pressure-fed vehicles, the propellant tank itself is maintained at the high pressure required to force propellant into the engine. To maintain this higher pressure, a pressure-fed vehicle requires a much higher mass of pressurant gas than a pump-fed vehicle.

Pressure-fed systems may use a tank of high-pressure gas, which is routed into a lower-pressure tank to maintain pressure in that lower-pressure tank, or they may provide gas using a gas generator. A gas generator is a system which transforms a liquid or solid into a high-pressure gas.

In a pressurization system, the pressurization gas piped into the propellant tank. It is advantageous for the pressurant gas to be delivered to the propellant tank relatively hot. Hot gas is less dense at a given pressure, and so using a hot gas allows the tank to be pressurized using a lower mass of pressurant gas.

A problem with using hot gas is that the propellant can cool the gas. This is particularly true in the case of cryogenic propellant, and in cases where the propellant sloshes within the tank, the cooling may occur in an unpredictable manner. Accordingly, a system is needed to minimize heat transfer from the pressurant gas to the propellant and make it more predictable.

Pressure fed vehicles offer a possible route to low cost, but the problem is that high pressure pressure vessels are too heavy if made from metal. Pressure vessels need baffles for slosh control and to prevent gas mixing, but composite baffles for LOX would be a hazard, and metal baffles put differential thermal expansion induced loads on the composite pressure vessel. What is needed is a system of a composite pressure vessel that has a LOX-compatible internal baffle system that does not pre-load the pressure vessel, and is manufacturable.

### OBJECTS OF THE INVENTION

A primary object of the present invention is to pressurize propellant tanks on a rocket stage, using a relatively low mass of pressurant gas.

A related object of the invention is to reduce circulation of the pressurant gas within the pressure vessel, whereby heat exchange between the gas and the propellant is minimized.

A related object of the invention is to provide a slow temperature rise for a given point on the wall of the pressure vessel, by increasing the temperature of the pressurant gas as the propellant empties out of the pressure vessel.

A secondary object of the present invention is to reduce strain on the vehicle's guidance system by preventing the propellant from sloshing.

Other objects, advantages and novel features of the present invention will become apparent from the following detailed description of the invention when considered in conjunction with the accompanying drawing.

### SUMMARY OF THE INVENTION

The present invention is a gas pressurization system for a pressure-fed rocket stage. It comprises a source of hot pressurant gas, a pressure vessel, a diffuser, and a baffle. The baffle comprises a set of tubes running along the length of the propellant tank and dividing it into subchambers with a low ratio of width to length. In one embodiment, a series of perforated dividers is mounted within the tubes, distributed along their length.

The pressurant gas is delivered hot, to reduce the mass of gas required to fill the volume of the pressure vessel at the target pressure. The diffuser deflects the flow of the pressurant gas as it enters the pressure vessel, reducing mixing of the entering gas with cooler gas inside the vessel, and preventing the stream of entering gas from blowing directly on the cold propellant. The baffle further reduces circulation of the pressurant gas, and reduces the sloshing of propellant, thus reducing both contact between the propellant and gas, and sloshing-induced circulation of gas.

The pressurant gas heater has a controller which controls the temperature the pressurization gas it heated to before it is introduced into the pressure vessel propellant tank. The controller initially causes cooler gas to be introduced into the tank, and then gradually raises the temperature over the duration of the engine burn on the rocket stage. This minimizes the thermal shock on the walls of the pressure vessel. The thrust that the stage is under due to the rocket engine firing helps keep the gas in stratified layers, so a given point of the pressure vessel wall experiences a gradual increase in local gas temperature.

The pressure vessel is constructed with baffles assembled with feet springs locked. The composite pressure vessel wall is wound around the assembled baffle system. After the mandrel is removed, adhesive is injected under the feet, and the fixed feet and spring feet are afixed to the pressure vessel. This allows the metal baffles to expand and contract without loading the pressure vessel structure.

### SHORT DESCRIPTION OF DRAWINGS

FIG. 1 is a side view of a rocket stage equipped with the invention.

FIG. 2 is a partial sectional perspective view of a pressure vessel equipped with the invention, showing the structure and placement of the baffle.

FIG. 3 is a cross-sectional perspective view of the propellant tank and baffle, with perforated dividers.

FIG. 4 is a view of the gas diffuser at the tank gas inlet.

FIG. 5 is a cross-sectional perspective view of the propellant tank configured with concentric cylindrical baffles.

FIG. 6 is a detailed view of the perforated horizontal dividers.

FIG. 10 is a schematic cross section view of a composite pressure vessel with the baffle system of the present invention.

FIG. 12A is a schematic cross section view perpendicular to the centerline axis of the pressure vessel, illustrating one embodiment of the baffle arrangement of the present invention.

FIG. 12B is a schematic cross section view perpendicular to the centerline axis of the pressure vessel, illustrating another embodiment of the baffle arrangement of the present invention.

FIG. 13 is schematic of the connection systems of the present invention.

FIG. 14 is a schematic cross section of a single baffle sheet of the present invention.

FIG. 15 is a schematic of a stress relieved connection system of the present invention.

FIG. 16 is a pictorial view showing the various states of the pressure vessel during the manufacturing process of the present invention.

### DETAILED DESCRIPTION OF INVENTION

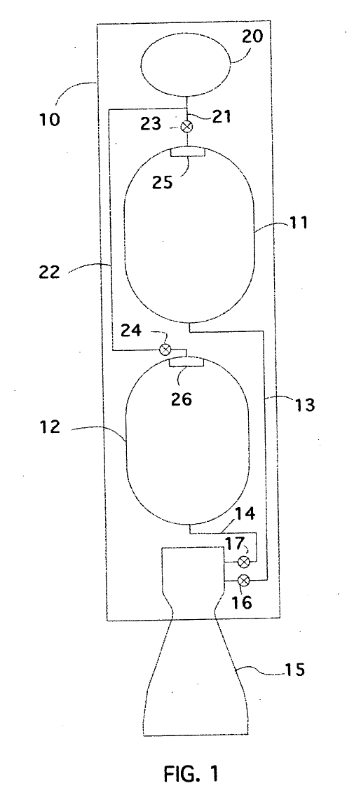

Referring to FIG. 1, the invention is installed on a rocket stage 10, to provide pressure to force propellant from propellant tanks 11 and 12 through propellant conduits 13 and 14 and into the combustion chamber of the engine 15. Flow of propellant into the engine 15 is regulated by propellant regulators 16 and 17. Hot pressurant gas is provided by the pressurant gas source 20. Pressurant gas is delivered to propellant tanks 11 and 12 via pressurant gas conduits 21 and 22. Flow of pressurant gas into propellant tanks 11 and 12 is regulated by pressurant regulators 23 and 24. Diffusers 25 and 26 diffuse the pressurant gas as it enters the propellant tanks. The invention could be used on both the fuel and oxidizer tank, or just the fuel tank, or just the oxidizer tank.

The pressurant gas source 20 includes a gas stored at high pressure, or a gas generator. In the case of the gas stored at high pressure, preferably the gas source 20 would also include a heater, to heat the gas prior to feeding it to the propellant tanks. In the case of a gas generator, a heater is employed, in one embodiment, to transform a liquid such as liquid nitrogen into a gas and raise it to a predetermined temperature prior to feeding it into the propellant tanks. Alternatively, in a gas generator, a liquid or solid is caused to chemically decompose, or burned, and thus produce exhaust gas at a temperature suitable for feeding into the propellant tanks. Liquids suitable for such use include hydrogen peroxide, and solids similar to solid rocket propellants is used. The heater could consist of a heat exchanger where heat from decomposed peroxide is used to heat the gas or liquid. It could also consist of a heat exchanger where heat from the products of a fuel oxidizer burner are used to heat the gas or liquid.

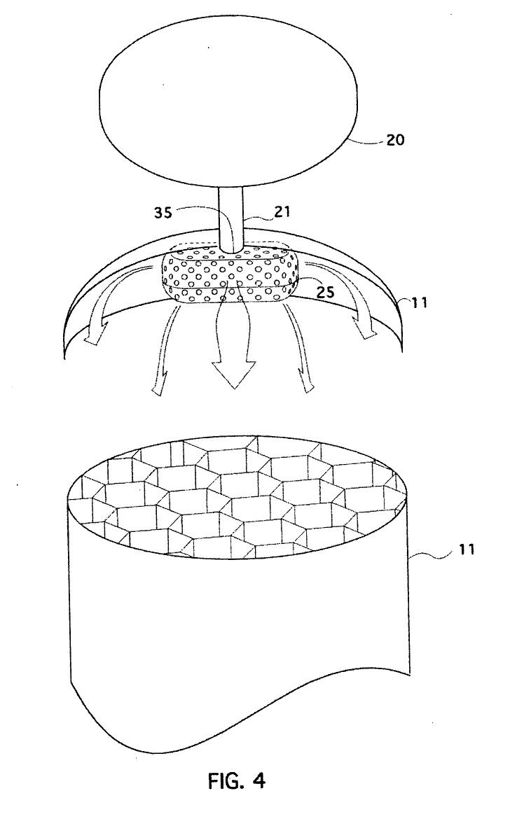

Referring to FIG. 4, the diffuser is mounted at the pressurant inlet 35, where the pressurant gas conduit 21 enters the propellant tank 11 (only one diffuser, and one gas conduit, is shown in FIG. 4). The diffuser forces the pressurant gas to enter the propellant tank 11 through a plurality of holes, in a range of orientations, rather than in a focused jet. Thus large-scale gas turbulence inside the propellant tank is reduced, and the entering hot gas is prevented from blowing directly at the cold propellant.

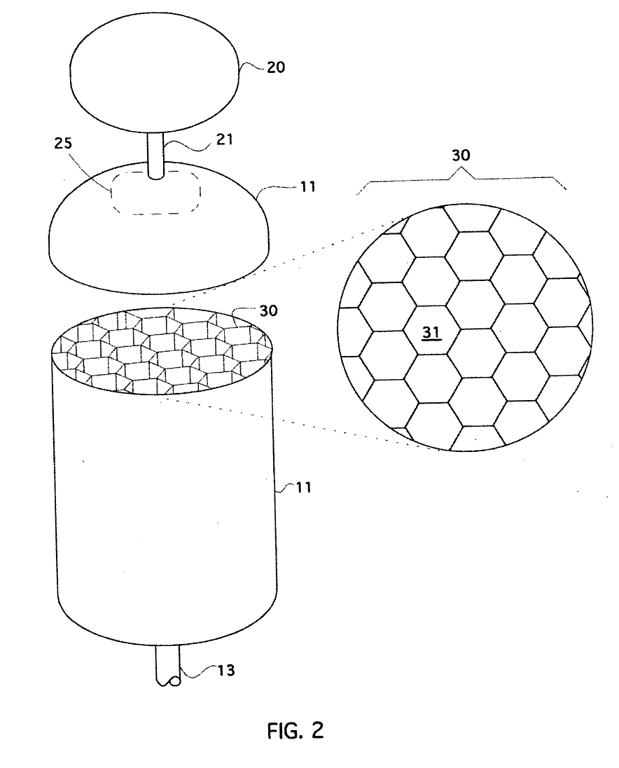

Referring to FIG. 2, inside each propellant tanks is mounted a baffle 30 (only one propellant tank, and one baffle, is shown in FIG. 2). The baffle comprises a plurality of tubes 31, oriented parallel to the direction of thrust of the rocket stage and joined into a body. In the main embodiment, the tubes are of hexagonal cross-section, but other cross-sections are possible.

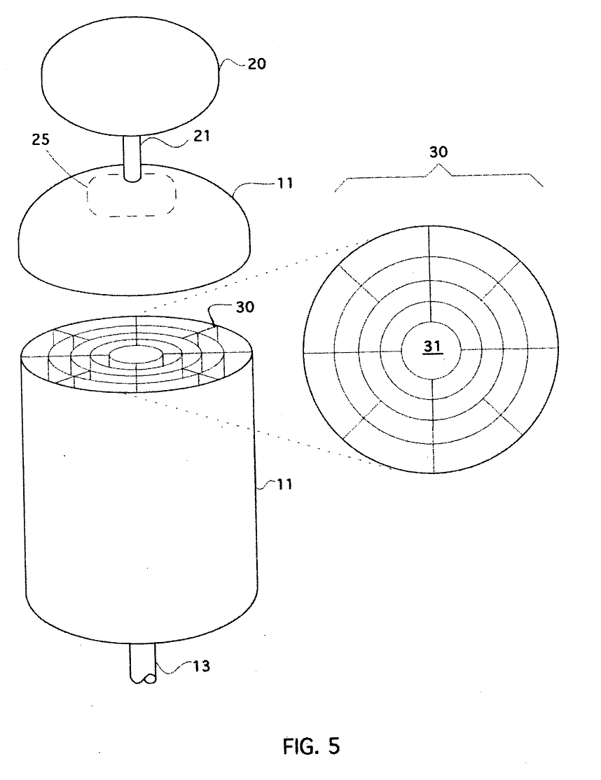

Referring to FIG. 5, a configuration of concentric cylindrical baffles is shown.

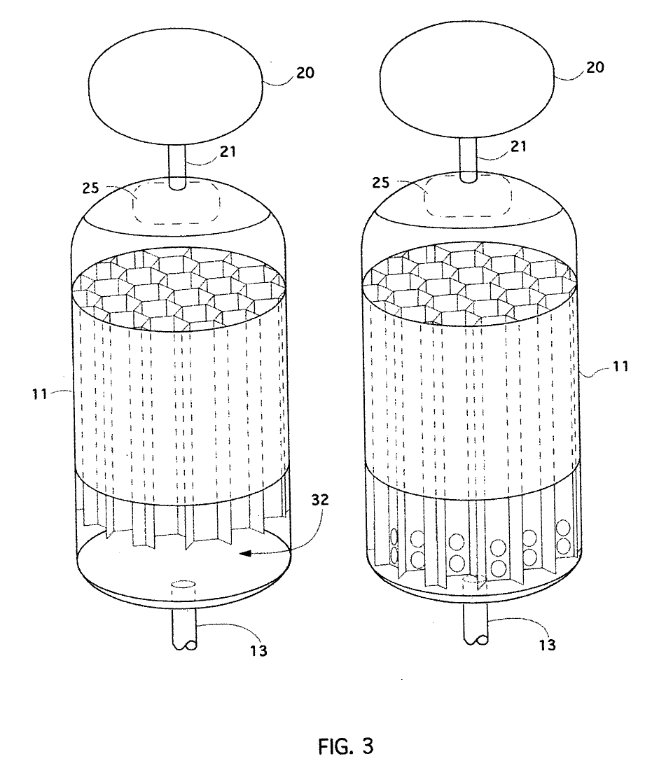

Referring to FIG. 3, the ends of the tubes composing the baffle are left open, and gaps 32 are left between the ends of the tubes and the interior surface of the tank 11, to allow the propellant to flow out of the ends of the tubes and into the propellant conduit 13. Alternatively, apertures in the ends of the walls of the tubes allows the propellant to flow out through the propellant conduit 13. The tubes prevent large-scale sloshing of the propellant. As a result they reduce the contact surface between the pressurant gas and the fuel, reduce sloshing-induced circulation of the pressurant gas, and reduce sloshing-related demands on the vehicle's attitude control system. The tubes also reduce circulation of the pressurant gas within the propellant tank.

Contact between the cold propellant and the hot pressurant gas within the propellant tank causes the gas to become cooler. The purpose of the baffle is to minimize this cooling. By reducing circulation of the pressurant gas, the baffle prevents cool gas near the propellant from mixing with the hot gas closer to the pressurant gas inlet 35. It also prevents hot gas from displacing cool gas near the propellant and itself being cooled by the propellant, maintaining the gas in generally stratified temperature layers in the stage, helped by the fact that the cooler gas will sink due to the thrust of the rocket.

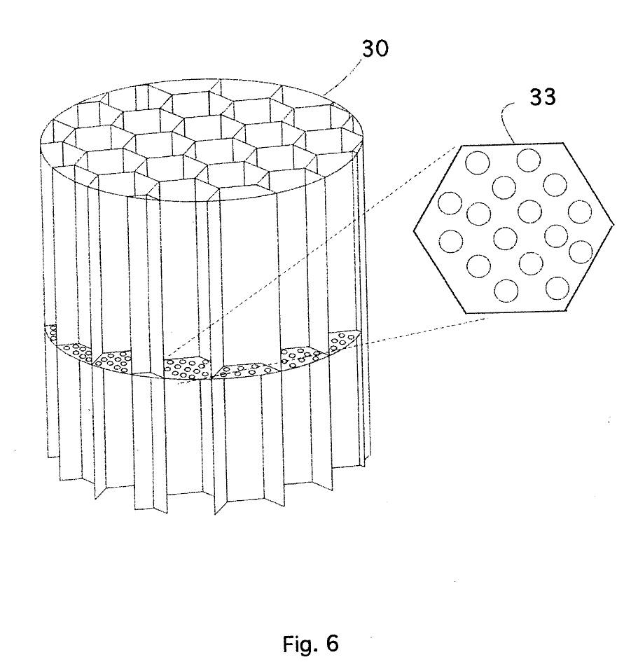

Referring to FIG. 6, the baffle's effectiveness is improved by perforated dividers 33 mounted at intervals along the length of the tubes. The perforated dividers 33 further reduce gas circulation. Perforations in the dividers allow propellant to flow uniformly in a direction toward the bottom of the stage, and allow pressurant gas to flow in a similarly uniform manner, displacing the propellant as it is expelled to the engine. The dividers further resist any tendency of cold gas to mix with hot gas, and of hot gas to approach near the propellant.

The pressurant gas heater has a controller which controls the temperature the pressurization gas it heated to before it is introduced into the pressure vessel inlet 35. In the preferred embodiment, the controller initially causes cooler gas to be introduced into the tank, and then gradually raises the temperature over the duration of the engine burn on the rocket stage.

The combined effects of the diffuser and baffle allow the average temperature of the pressurant gas and tank to be higher than it would be otherwise. This higher temperature allows the tank to be pressurized to given pressure with a smaller mass of gas than would be required if the gas was allowed to circulate readily. The baffle system also makes the behavior of the liquid gas interactions more predictable and easier to model. Lower pressurant mass leads to better performance from the rocket, i.e., being able to loft larger mass payloads into orbit. High average temperature also allows heavier gas, such as nitrogen to be used in place of helium, with a smaller penalty in pressurant gas mass as there would be otherwise. As a gas generating liquid, nitrogen has the advantage of being liquid at normal cryogenic temperatures, and being easier to handle than liquid helium. The temperature ramp the gas heater controller gives the pressurant gas minimizes the thermal shock on the walls of the pressure vessel, so a given point of the pressure vessel wall experiences a gradual increase in local gas temperature.

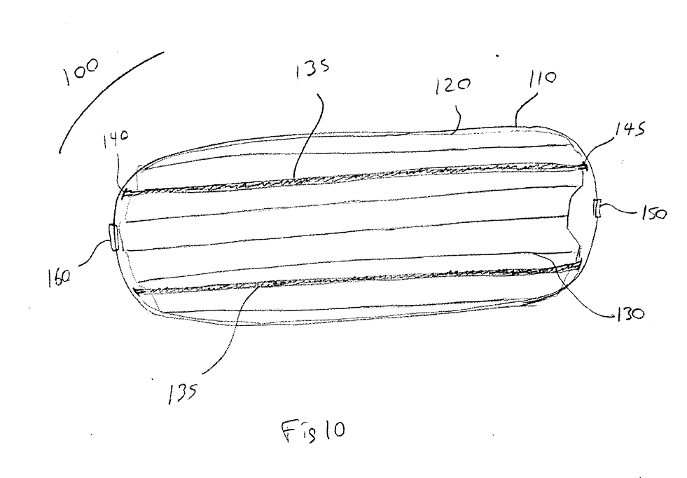

FIG. 10 through FIG. 16 describe an embodiment of the present invention wherein the baffle system is used in a composite pressure vessel. The baffle construction is described in detail, as well as the method to fabricate a composite propellant tank around the baffle and attach the baffle to the propellant tank.

FIG. 10 is a schematic cross sectional view of a composite pressure vessel with the baffle system of the present invention. As depicted, the composite pressure vessel with baffle system (100) includes: a fiber wound composite pressure vessel (110), a thin impermeable liner (120), and baffle sheets (130), longitudinal support members (135), fixed connections (140), sliding connections (145), pressurant gas inlet (150), and a propellant outlet (160). The composite pressure vessel (110) is a filament wound system constructed utilizing carbon-fiber reinforcement.

The thin impermeable liner (120) is a coating designed to adhere to the inside of the composite pressure vessel (110), and prevent high pressure LOX from being able to infiltrate the composite matrix during operation. This minimizes the chance of the pressure vessel exploding or igniting under impact loads or heating.

The baffle sheets (130) are very thin-gauge metal sheets that are bent in such a way that at cryogenic temperatures, can shrink and put only minimal lateral loads on the longitudinal support members (135).

The longitudinal support members (135) are used to connect the baffle sheets to the two ends of the composite pressure vessel (110). They are hollow to allow a greater stiffness and buckling resistance for a given mass. In one embodiment, they have openings at either end to allow the propellant to fill and empty the inside of the tubes.

The fixed connections (140) connect the longitudinal support members (135) rigidly to the composite pressure vessel (110) and transmit small lateral forces induced by the propellant during launch.

The sliding connections (145) are firmly attached to the composite pressure vessel (110), and constrain the longitudinal support members (135) from moving in a radial or circumferential direction. However they allow the longitudinal support members (135) to slide vertically as the metal shrinks when exposed to cryogenic propellant. This sliding connection eliminates large thermal stresses from being placed on the ends of the pressure vessel.

In one embodiment, the longitudinal support members do not extend the full length of the tank. In this embodiment, the longitudinal support rods connect from the inside ends of the tank to the baffles and the baffles are structurally self-supporting.

The fill and drain valve fittings (150) are configured in one embodiment to be a single fitting that can be used for both filling and draining.

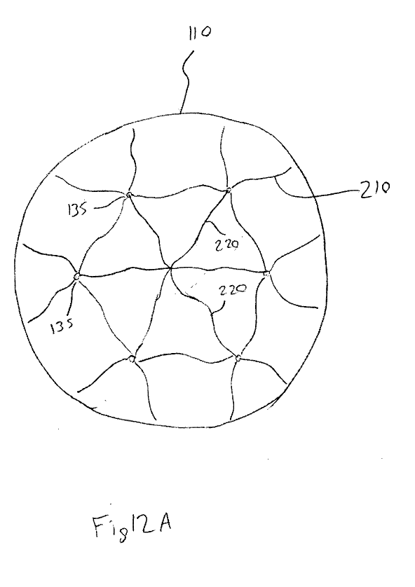

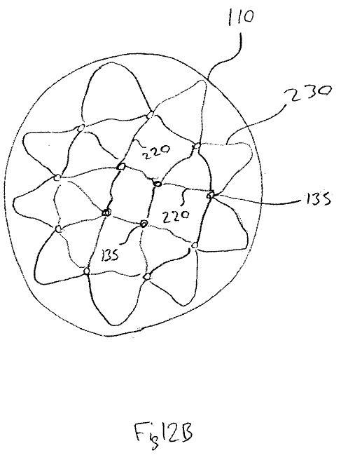

FIG. 12A is a schematic cross sectional view perpendicular to the centerline axis of the pressure vessel, illustrating one embodiment of the baffle arrangement of the present invention. As depicted, this baffle system includes: outer cantilevered baffle sheets (210), inner baffle sheets (220), longitudinal support members (135), and the composite pressure vessel (110).

In one embodiment, each baffle support tube (135) is connected to five baffle sheets (130), and the support tubes are arranged in a single circular pattern at a certain distance from the centerline. Two of the sheets are cantilevered outwards (210) toward the propellant pressure vessel walls (110). Two of the sheets (220) are connected, one each to the baffle support tube on either side in the circular pattern. The last sheet (220) is directed radially inward, connecting with similar sheets from each other support tube in the center of the propellant pressure vessel.

FIG. 12B is a schematic cross sectional view perpendicular to the centerline axis of the pressure vessel, illustrating another embodiment of the baffle arrangement of the present invention. As depicted, this embodiment of the baffle system also includes: bent outer baffle sheets (230), inner baffle sheets (220), longitudinal support members (135), and the composite pressure vessel (110).

In this embodiment, the longitudinal support members (135) are arranged in two concentric rings with each of the outer support tubes (250) having at least three baffle sheets (130) attached to it, and each inner support tube (240) having at least three inner baffle sheets (220) attached to it. The specific number of sheets attached to each tube depends on the number of inner support tubes and outer support tubes. In this embodiment, the two sheets that extend outward radially (230) from the outer support tubes are bent around and connected to another one of the outer support tubes (250). The extra ring of support tubes (240) and having the bent outer baffle sheets (230) supported at two ends instead of cantilevered both add to the stiffness of the system.

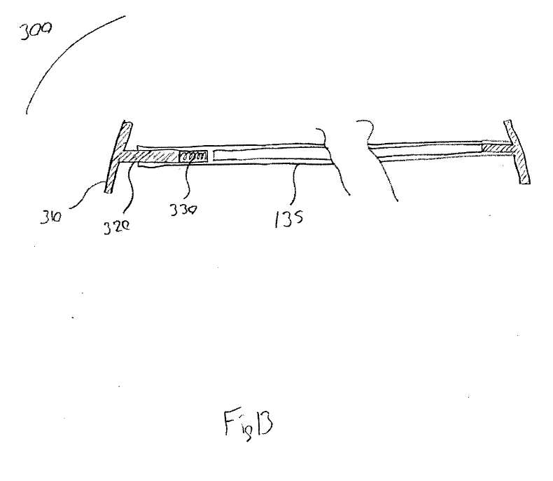

FIG. 13 is a cross sectional view of the connection systems of the present invention. As depicted, the connection systems (300) include: mounting plates (310), mounting posts (320), springs (330), and a longitudinal support rod (135).

On each end, the mounting plates (310), which are slightly curved to match the inner surface of the pressure vessel at the location at which they are attached, have mounting posts (310) welded to them. On the fixed end, the longitudinal support members (135) are welded to the mounting posts (320). On the free end, springs (330) are placed around the mounting posts (320) between the mounting plates (310) and the longitudinal support members (135). The spring is facilitate the manufacturing process by allowing the baffle assembly to be compressed while the composite tank is being wound.

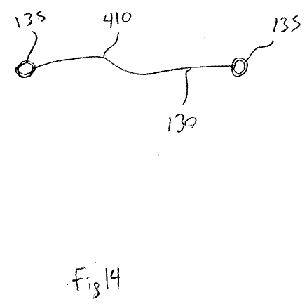

FIG. 14 is a schematic cross section of a single baffle sheet of the present invention. As depicted, the baffle sheet (130) includes: a bend (410), and the baffle support posts (135).

The bends (410) are configured in such a way as to allow the distance between baffle support posts (135) to be held constant as the metal shrinks when in contact with LOX. In one embodiment, the sheet is mostly flat with a bend (410) forming a small outward joggle near the midpoint of the sheet (130). In another embodiment, the sheet (130) has a slightly sinusoidal curve (with very low amplitude) between the two support posts (135).

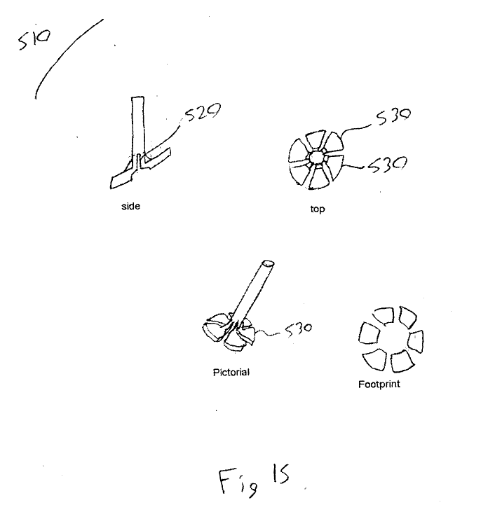

FIG. 15 is a top view, side view, a pictorial view, and a contact print of a stress-relieved connection system of the present invention. As depicted, the stress-relieved connection system includes: a single piece connection mounting plate/connection mounting post combination (510) with several slots (520) creating six feet (530).

The slots (520) in the single piece connector (510) help relieve radial stress in the connector caused by differential thermal contraction rates between it and the pressure vessel (110) to which it is mounted.

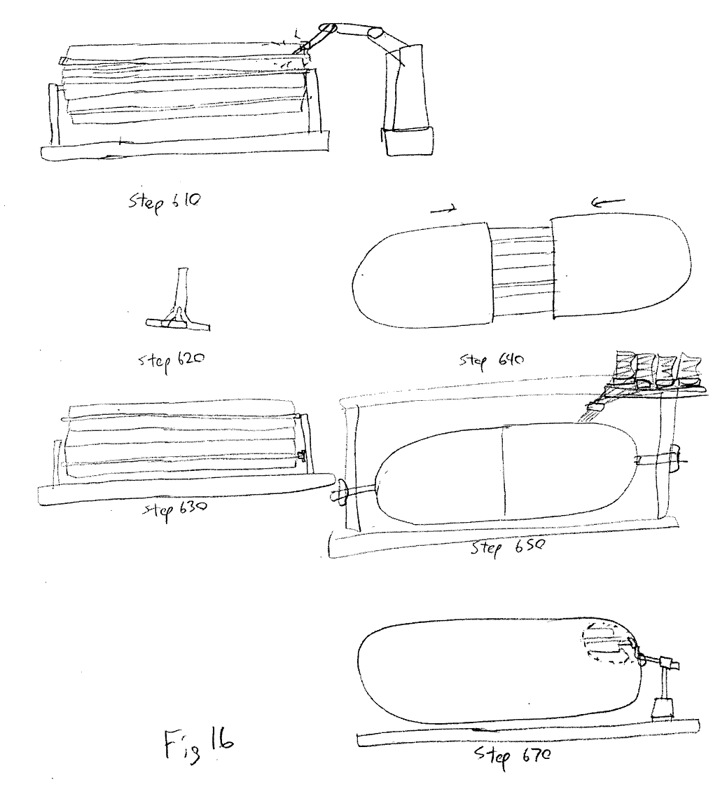

FIG. 16 is a pictorial view showing the various states of the pressure vessel during the manufacturing process of the present invention. As depicted, the manufacturing states include: the baffle sheets and the longitudinal support members being welded into the complete baffle structure (step 610), the connection system manufacture (620), attaching the connection systems to the baffle structure (630), fitting the assembly into the mandrel (640), wrapping the fiber pressure vessel (650), removing the mandrel by chemical dissolution (660), and a cut-away view of attaching the connection systems to the inside of the pressure vessel (670).

In the baffle structure manufacture step (610), the tubes (135) are cut and cleaned, the sheets (130) are cut and bent, and the whole structure is welded together. In one embodiment, a jig could be used to simplify the welding process. In one embodiment, the whole structure-is annealed after welding to remove any thermal stresses.

In one embodiment, the connection system is manufactured (620) from separate plates (310) which are formed and then posts (320) are welded on. In another embodiment, the connectors would be cast out of a suitable alloy, preferably with stress relief slots (520) cast into the part. In another embodiment, the connector (510) is milled out of a block of metal, with stress relief slots (520). On the slip-side connectors, a spring (330) attached to one end to the connector after being slid over the post.

The fixed connection systems are attached to the baffle structure (630) by welding. In one embodiment, this is done with the aid of an alignment jig to make the welding easier. The slip-side connectors are slid into the support tubes (135) in such a way that they can still slide in and out.

In one embodiment, the baffle system assembly is fit into the mandrel (640) by radially compacting both sets of outer connector so that the system can slide into the mandrel. In another embodiment, the structure is cast into a water-soluble mandrel using some sort of mold with positioning mounts to align all of the connectors.

In one embodiment, the mandrel is first coated with a LOX compatible liner before the fiber is wrapped on the mandrel (650). In another embodiment, the pressure vessel is wrapped first, and the liner is applied after the mandrel is removed (660). In order to reduce the thermal stresses in the pressure vessel when loaded with LOX, one embodiment of the fiber wrapping would use an e-beam cure instead of an autoclave cure. In another embodiment, UV or IR light would be used to cure the composite. In another embodiment, the composite matrix material would be a room-temperature curable polymer. Also, in one embodiment, the fiber would be emplaced on mandrel using a vibratory system to force any air bubbles out of the matrix prior to curing. In one embodiment, the wrappings would be cured on the mandrel as layers are added allowing the whole part to be completely cured within a short time of when the wrapping is finished.

After the fiber composite has been wrapped onto the mandrel and cured, the mandrel is then removed (660). In one embodiment, the mandrel is is dissolved out of the pressure vessel with an appropriate solvent, such as water. In another embodiment, the mandrel is a very-low melting point alloy or wax that is then melted out of the pressure vessel. In another embodiment, the mandrel is inflatable and is deflated, the baffle cut out, and slid out of the inside of the pressure vessel.

Lastly, after the mandrel is removed (660), the connection systems are then adhesively bonded to the inside of the pressure vessel (670). In one embodiment this is done with the aid of a small alignment jig. In one embodiment, the adhesive is applied through the port on either end using a small adhesive wand. The fixed connection systems are adhered first, and then the sliding connection systems are attached. The springs (330) help provide sufficient pressure to get a good adhesive bonding. The adhesive must be LOX compatible.

While the invention has been described in the specification and illustrated in the drawings with reference to a main embodiment and certain variations, it will be understood that these embodiments are merely illustrative. Thus those skilled in the art may make various substitutions for elements of these embodiments, and various other changes, without departing from the scope of the invention as defined in the claims. Therefore, it is intended that the invention not be limited to the particular embodiment illustrated by the drawings and described in the specification as the best mode presently contemplated for carrying out this invention, but that the invention will include any embodiments falling within the spirit and scope of the appended claims.

We claim:

1. A system for pressurizing propellant within a pressure-fed rocket that comprises:
a pressure vessel for holding propellant;
a source of pressurant gas;
a diffuser configured to spread the direction of gas entering the pressure vessel;
a configuration of longitudinal baffles oriented substantially parallel to the direction of thrust;
a regulator configured to regulate the gas flow into the pressure vessel.

2. The system of claim 1, wherein the pressurant gas is heated before being introduced into the pressure vessel.

3. The pressurant gas is heater of claim 2, wherein the heater is configured to provide cooler gas at the start of the engine burn, and to gradually increase the temperature of the pressurant gas as the propellant is consumed.

4. The system of claim 1, wherein the baffles are shaped in a shape selected from the group consisting of: hexagonals, concentric cylinders, concentric cylinders conjoined with radial baffles, squares, triangles.

5. The system of claim 1, wherein the baffles contain apertures at the base for the transfer of propellant to the vessel outlet.

6. The system of claim 1, further comprising perforated dividers mounted perpendicularly within the longitudinal baffles to reduce circulation of the gas.

7. The system of claim 1, wherein the pressurant gas is composed substantially of a gas selected from the group consisting of: helium, nitrogen.

8. A system for pressurizing propellant within a pressure-fed rocket that comprises:
a pressure vessel for holding propellant;
a source of pressurant gas;
a system for heating the pressurant gas before it is introduced into the pressure vessel;
a gas temperature controller to control the temperature the pressurant gas is heated to before being introduced into the pressure vessel;
a diffuser to spread the direction of gas entering the pressure vessel;
a regulator that regulates the gas flow into the pressure vessel.

9. The system of claim 8, where the pressure vessel has a configuration of longitudinal baffles oriented substantially parallel to the direction of thrust.

10. The system of claim 8, where the gas temperature controller is configured to heat the gas to a low temperature initially, and raise the temperature as the propellant is emptied from the tank.

11. A system for storing high pressure cryogenic propellant on a launch vehicle, comprising:
a composite pressure vessel;
a integral liner to the pressure vessel to prevent propellant infiltration into the composite matrix;
a metallic baffle system comprising:
1) a plurality of longitudinal support members, fixedly mounted at discrete locations at one end of the pressure vessel and slidably mounted at discrete points at the opposite end of the pressure vessel;
2) a plurality of baffle sheets attached to the longitudinal support members to form a plurality of longitudinal openings within the pressure vessel.

12. The system for storing high pressure cryogenic propellant on a launch vehicle claimed in claim 11, wherein the metallic baffle system is comprised of a metal selected from the group consisting of: stainless steel, aluminum.

13. The system for storing high pressure cryogenic propellant on a launch vehicle claimed in claim 11, wherein the composite pressure vessel is manufactured from a fiber selected from the group consisting of: T1000 carbon fiber, T700 carbon fiber.

14. The system for storing high pressure cryogenic propellant on a launch vehicle claimed in claim 11, wherein the composite pressure vessel integral liner is comprised of a material selected from the group consisting of: PAEPO by Triton Systems, Inc., DCPD by Cymtech LLC.

15. The system for storing high pressure cryogenic propellant on a launch vehicle claimed in claim 11, wherein the composite pressure vessel is further comprised of a gas port at the top of the pressure vessel.

16. The system for storing high pressure cryogenic propellant on a launch vehicle claimed in claim 11, wherein the connection system is configured to be spring-loaded at one end.

17. The system for storing high pressure cryogenic propellant on a launch vehicle claimed in claim 11, wherein the connection system spring is configured to be held compressed during assembly.

18. The system for storing high pressure cryogenic propellant on a launch vehicle claimed in claim 11, wherein the metallic baffles are configured with bends in them that provide radial thermal stress relief.

19. The system for storing high pressure cryogenic propellant on a launch vehicle claimed in claim 11, wherein the pressure vessel is further comprised of an internal liner compatible with liquid oxygen.

20. The system for storing high pressure cryogenic propellant on a launch vehicle claimed in claim 11, wherein the connection system is further comprised of several independent feet configured to provide thermal stress relief.
